(19) United States
(12) Patent Application Publication
(10) Pub. No.: US 2011/0085880 A1
(43) Pub. Date: Apr. 14, 2011

(54) Cart or load lift

(76) Inventors: Tye B. Davis, Hull, IA (US); Michael S. Wetter, Orange City, IA (US)

(21) Appl. No.: 12/587,618

(22) Filed: Oct. 9, 2009

(51) Int. Cl. B60P 1/00; B60P 1/48

(52) U.S. Cl. 414/546

(57) ABSTRACT

A cart or load lift is disclosed which is positioned within the body of a box truck or the like inwardly of a door opening formed in the side or rear of the box truck. The lift includes a load support located on the outer ends of a pair of parallel arm assemblies so that the load support may be moved from a stowed position within the vehicle to a lowered position outwardly of the vehicle to enable a cart or load to be positioned thereon and then raised upwardly and inwardly into the vehicle.

### BACKGROUND OF THE INVENTION

1. Field of the Invention

This invention relates to a cart or load lift and more particularly relates to a cart or load lift which is positioned within the body of a box truck or the like inwardly of a door opening formed in the side or the back of the box truck and which may reach outwardly and downwardly through the door opening to enable a cart or load to be positioned thereon and then raised upwardly to move the cart or load to the interior of the box truck. The cart or load lift is ideally suited to raise and lower linen or laundry carts but is suited to raise and lower other types of loads as well.

2. Description of the Related Art

In the laundry business, soiled laundry is frequently placed within a wheeled laundry or linen cart. In some laundry businesses, the filled laundry carts are loaded into a box truck or the like. In some cases, when the filled cart has been moved into the interior of the box truck, a worker separates the soiled laundry or linen and places the soiled laundry into bins or containers within the box truck. The empty cart is then removed from the body of the truck and the truck is driven to a facility where the soiled laundry is washed.

The task of loading the carts into the body of the truck is difficult due to the weight of the cart and the contents thereof.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A cart or load lift is described which is ideally suited for lifting laundry or linen carts from the ground wherein the cart is raised upwardly and inwardly and is passed through a door opening in the body of a truck. Although the lift is ideally suited to raise and lower laundry or linen carts, the lift is also ideally suited to raise and lower other types of loads as well. The lift includes a first support which is secured to the floor of the vehicle within the body inwardly of the door opening and which has a first side, a second side, an inner end, an outer end, a lower end and an upper end. A second support is secured to the floor of the vehicle inwardly of the door opening spaced from the first support and which has a first side, a second side, an inner end, an outer end, a lower end and an upper end. The lift includes a first parallel arm assembly including first and second elongated parallel arms having first and second ends. The first ends of the first and second parallel arms of the first parallel arm assembly are pivotally secured, about horizontal axes, to the first support. The lift also includes a second parallel arm assembly including first and second elongated parallel arms having first and second ends. The first ends of the first and second parallel arms of the second parallel arm assembly are pivotally secured, about horizontal axes, to the second support. The lift further includes a cart or load support having a first end, a second end, an upper end and a lower end. The second ends of the first and second parallel arms of the first parallel arm assembly are pivotally secured to the upper end of the cart or load support at the first end thereof about horizontal axes. The second ends of the first and second parallel arms of the second parallel arm assembly are pivotally secured to the upper end of the cart or load support about horizontal axes. The cart or load support includes at least one, and preferably two, cart or load support members which extend outwardly from the lower end thereof and which are adapted to have a cart or load positioned thereon.

The first parallel arm assembly, the second parallel arm assembly and the cart or load support are movable in unison between a first loading/unloading position to a second stowed position within the body of the truck. A first hydraulic cylinder is operatively secured to and extends between the first support and the first parallel arm assembly and a second hydraulic cylinder is operatively secured to and extends between the second support and the second parallel arm assembly to move the cart or load support between its first and second positions. The first and second parallel arm assemblies are movable so as to extend outwardly through the door opening so that the cart or load support members are positioned outwardly of the interior of the body of the vehicle to permit a cart or load to be positioned thereon when the first parallel arm assembly, the second parallel arm assembly and the cart or load support are in the first position. The first and second parallel arm assemblies extend upwardly and inwardly from the first and second supports respectively when the first parallel arm assembly, the second parallel arm assembly and the cart or load support are in the second position so that a cart or load positioned on the cart or load support members will be positioned within the interior compartment of the vehicle body.

A stand is also provided which is secured to the floor of the vehicle inwardly of the first and second supports. When the cart or load support is in its second position, the cart or load will be positioned on the stand and cushioned thereon by a pair of bumpers. The stand also enables a person to stand thereon to reach downwardly to reach into the cart to remove the contents thereof when the cart is in the second stowed position within the vehicle.

It is therefore a principal object of the invention to provide an improved cart or load lift.

A further object of the invention is to provide a cart or load lift which is ideally suited for use with laundry or linen carts.

A further object of the invention is to provide a cart or load lift which may be positioned in a stowed position within the body of a vehicle and moved outwardly through a door opening formed in the side or rear of the body so that a cart or load may be loaded thereon.

A further object of the invention is to provide a cart or load lift including safety means for preventing free-fall of the cart or load should hydraulic failure occur.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a first perspective view of the cart or load lift of this invention in its stowed position;

FIG. 2 is a perspective view of the cart or load lift of this invention in its loading/unloading position;

FIG. 3 is a perspective view of the stand portion of the cart or load lift;

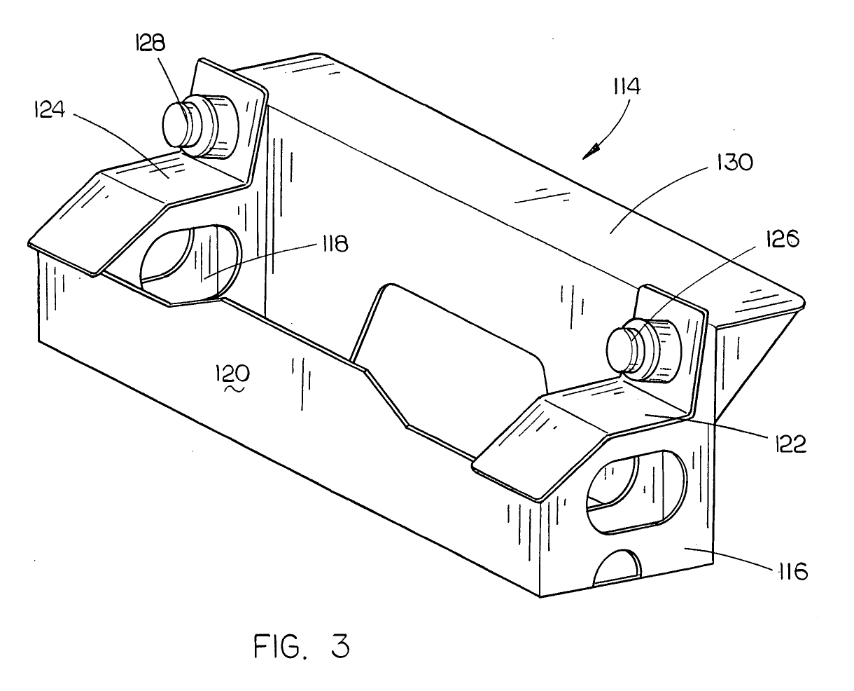

FIG. 4 is a partial side view illustrating the cart lift mounted in a vehicle body or box with the cart lift being in its loading/unloading position;

FIG. 5 is a partial side view illustrating the cart lift in its stowed position; and

FIG. 6 is a schematic illustrating the flow controls which are associated with the hydraulic cylinders of the invention.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The lift apparatus of this invention will be described as a cart lift for purposes of description with the understanding that the lift is suited to raise and lower other types of loads. The lift apparatus of this invention is referred to by the reference numeral 10 and is ideally suited to lift linen or laundry carts 11 or the like although the apparatus 10 could be used to raise and lower other types of equipment or loads if so desired as stated above. The apparatus 10 is designed to be used with a conventional wheeled vehicle such as a box truck 12 having a box or body 14 mounted thereon including a floor 16 and a door opening 18 formed in one side thereof or in the rear thereof. If the apparatus 10 is being used to raise and lower laundry or linen carts 11, the interior of the box or body will normally have various linen or laundry bins positioned therein.

The apparatus 10 includes a first support 20 which is secured to the floor 16 inwardly of the door opening 18. First support 20 will be described as including an outer end 22, an inner end 24, an upper end 26, and a lower end 28. Apparatus 10 also includes a second support 30 which is secured to the floor 16 inwardly of door opening 18 and which is spaced from the first support 20. The second support 30 will be described as including an outer end 32, an inner end 34, an upper end 36 and a lower end 38. The numeral 40 refers to a first parallel arm assembly which includes elongated parallel arms 42 and 44 having inner and outer ends. The inner ends of arms 42 and 44 are pivotally secured to the first support 20, about horizontal axes, at 46 and 48 respectively. The base end 50 of a double acting hydraulic cylinder 52 is pivotally connected to the upper end 26 of first support 20 at 54. The rod end of hydraulic cylinder 52 is pivotally connected at 56 to the bracket 58 which is secured to parallel arm 42.

The numeral 60 refers to a second parallel arm assembly which includes elongated parallel arms 62 and 64 having inner and outer ends. The inner ends of arms 62 and 64 are pivotally secured to the second support 30, about horizontal axes, at 66 and 68 respectively. The base end 70 of a double acting hydraulic cylinder 72 is pivotally connected to the upper end 36 of second support 30 at 74. The rod end of hydraulic cylinder 72 is pivotally connected at 76 to the bracket 78 which is secured to parallel arm 62. Brace or rod 80 has its opposite ends secured to the upper ends of brackets 58 and 78 and extends therebetween.

The numeral 82 refers to a cart or load support assembly which is pivotally secured to the outer ends of parallel arms 42, 44, 62 and 64 as will now be described. Cart or load support assembly 82 includes a first frame member 84 having an upper end 86 and a lower end 88. The outer ends of parallel arms 42 and 44 are pivotally secured to the upper end 86 of frame member 84 at 90 and 92 respectively. Cart or load support assembly 82 also includes a second frame member 94 having an upper end 96 and a lower end 98. The outer ends of parallel arms 62 and 64 are pivotally secured to the upper end 96 of frame member 94 at 100 and 102 respectively.

Cart or load support assembly 82 includes a frame member 104 which is secured to the upper ends of frame members 84 and 94 and which extends therebetween. Cart or load support assembly 82 also includes a frame member 106 which is secured to the lower ends of frame members 84 and 94 and which extends therebetween. Frame member 108 is secured to frame members 104 and 106 and extends therebetween. A pair of elongated cart or load support members 110 and 112 are secured to frame member 106 and extend outwardly therefrom. Any number of cart or load support members may be utilized.

The numeral 114 refers to a stand which is secured to the floor of the vehicle at the inner sides of the first support 20 and the second support 30. Stand 114 includes a pair of end portions 116 and 118 having a plate 120 secured thereto and extending therebetween. End portions 116 and 118 include support ledges 122 and 124 and MCU bumpers 126 and 128 positioned thereabove respectively. The inner side of stand 114 has a step 130 extending between the end portions 116 and 118.

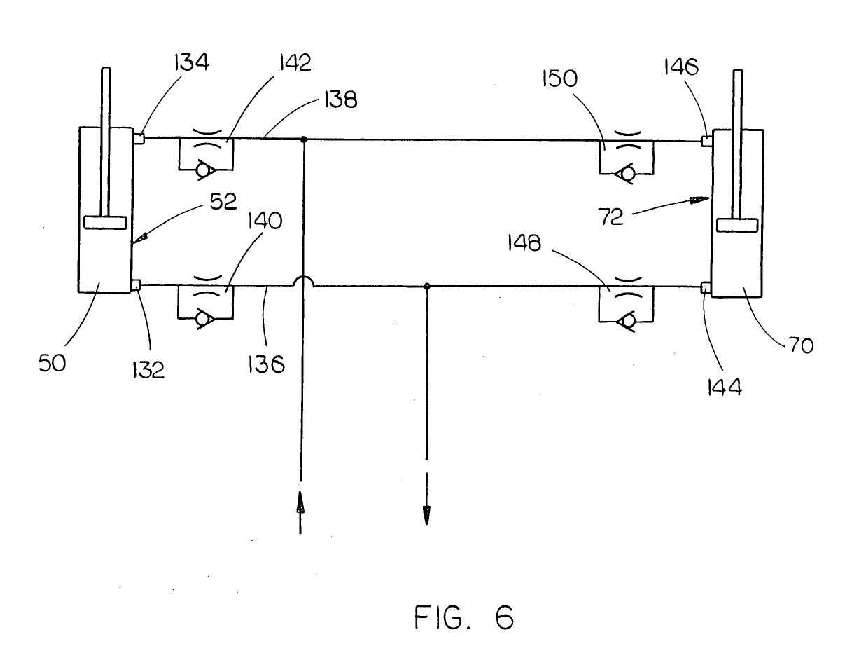

FIG. 6 is a schematic which illustrates the hydraulic cylinders 52 and 72 having flow controls associated therewith. The base end 50 of hydraulic cylinder 52 has a fitting 132 provided thereon while the other end of cylinder 52 has a fitting 134 provided thereon. Hydraulic hoses, lines or conduits 136 and 138 extend from fittings 132 and 134 respectively. Flow controls 140 and 142 are mounted on the fittings 132 and 134 respectively or are imposed in conduits 136 and 138 respectively. The base end 70 of hydraulic cylinder 72 has a fitting 144 provided thereon while the other end of cylinder 72 has a fitting 146 provided thereon. Flow controls 148 and 150 are mounted on the fittings 144 and 146 respectively or are imposed in hydraulic hoses, lines or conduits 136 and 138 which extend from fittings 144 and 146 respectively.

As seen in FIG. 6, lines 136 and 138 connect the cylinders 52 and 72 in a parallel manner. The flow controls 140, 142, 148 and 150 are provided to prevent a free-fall of the cart support 82 in the event of a hydraulic hose, line or conduit failure. The flow controls also provide controlled movement of the load during the lifting and lowering motions.

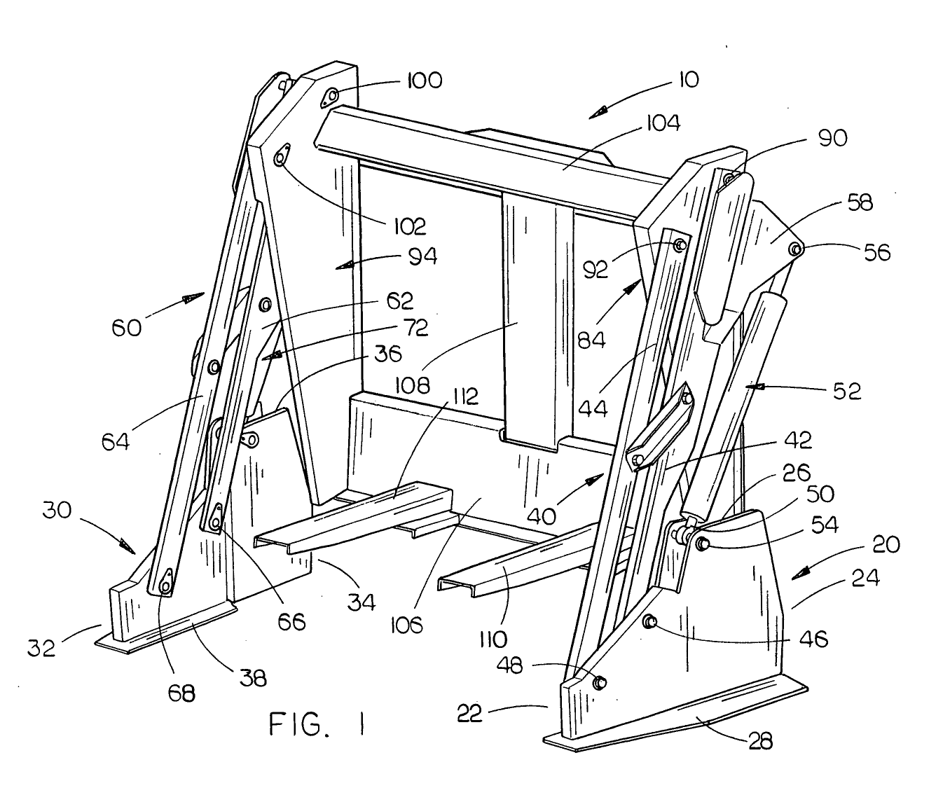

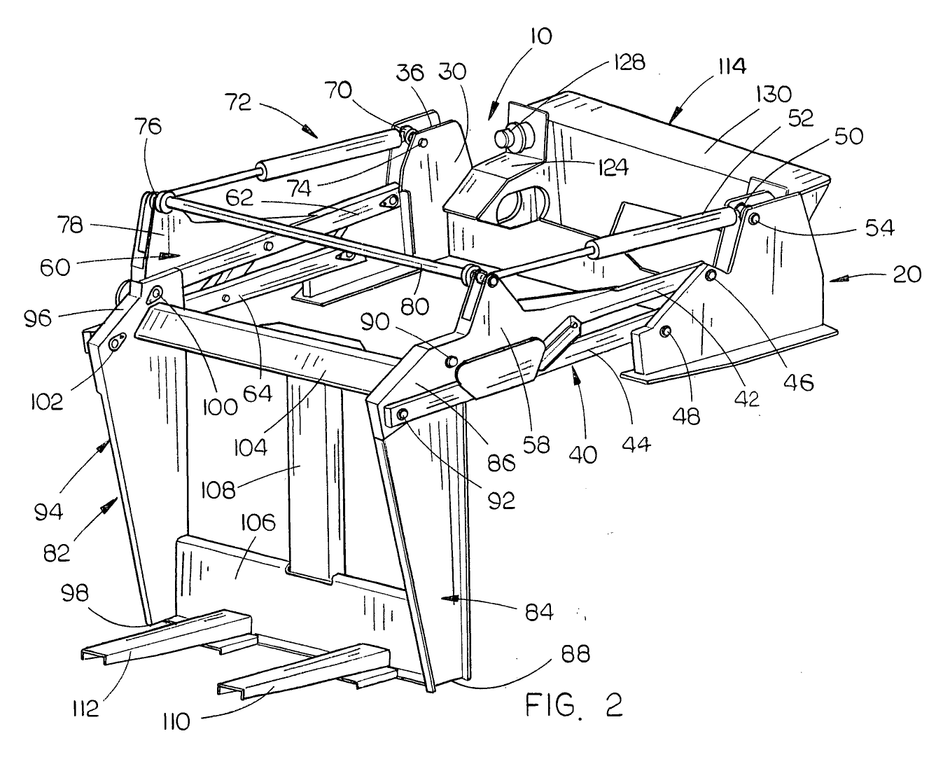

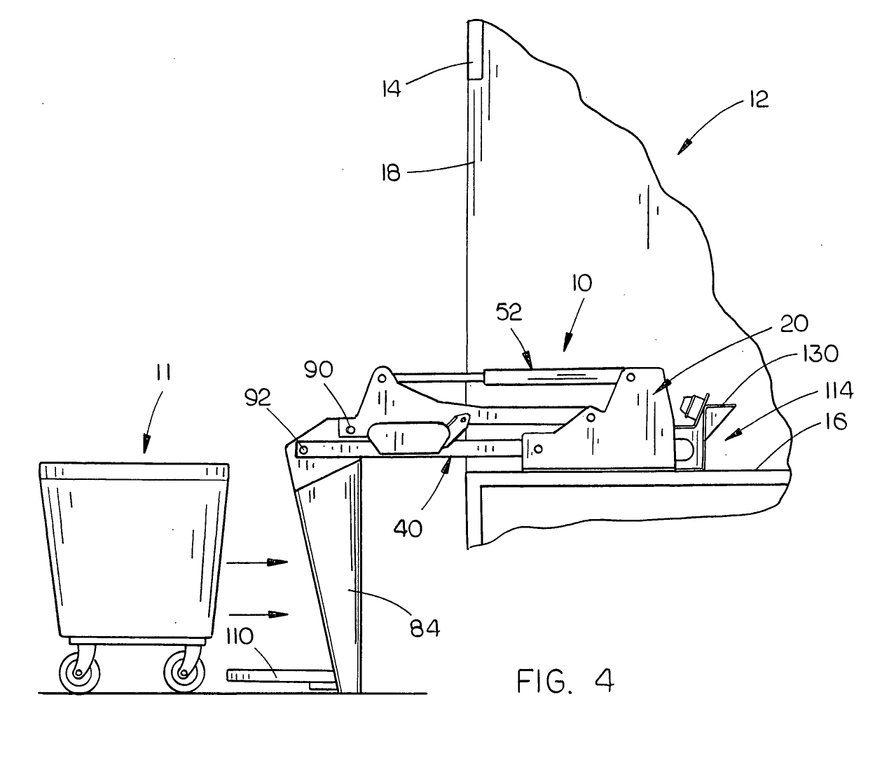

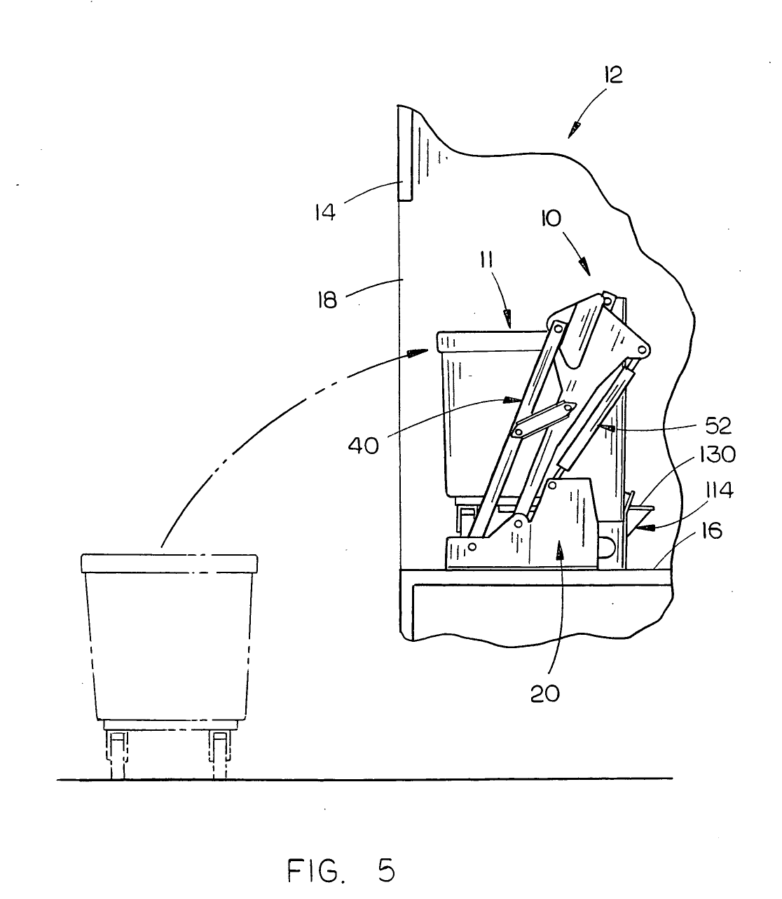

The cart or load lift apparatus 10 of this invention is utilized as follows: The apparatus 10 is normally in the stowed position of FIG. 5 with the hydraulic cylinders 52 and 72 being in the retracted position. As seen in FIG. 1, when the hydraulic cylinders 52 and 72 are in their retracted positions, the parallel arm assemblies 40 and 60 extend upwardly and inwardly from the supports 20 and 30 respectively so as to be in an over-the-center position. When it is desired to load a cart 11 onto the apparatus, the hydraulic cylinders 52 and 72 are extended which causes the parallel arm assemblies 40 and 60 to be pivotally moved from the position of FIGS. 1 and 5 to the position of FIGS. 2 and 4. The cart 11 may then be positioned on the supports 110 and 112. The hydraulic cylinders 52 and 72 are then retracted which causes the parallel arm assemblies 40 and 60 to be pivotally moved from the position of FIGS. 2 and 4 to the position of FIGS. 1 and 5. When the cart 11 is in the position of FIG. 5, the cart rests on the surfaces 122 and 124 of the stand 114 with the bumpers 126 and 128 cushioning the same. A person may then stand on the step 130 of stand 114 so as to reach over and downwardly into the cart 11 in a convenient manner. If the cart is a linen or laundry cart, the person may remove the contents from the cart 11 and place the same in various bins located throughout the truck box. When the cart has been emptied, it may be lowered to the ground or left remaining on the stand 114.

Although the apparatus 10 of this invention has been described as being well suited for use in lifting laundry or linen carts, the apparatus 10 may also be used to raise and lower various other types of loads as previously described. Thus it can be seen that the invention accomplishes all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

We claim:

1. (canceled)

2. (canceled)

3. (canceled)

4. The combination of claim 16 wherein said stand includes a cushioning bumper thereon.

5. The combination of claim 4 wherein said stand includes a step portion thereon to enable a person to stand thereon.

6. The combination of claim 16 wherein said means for moving said front parallel arm assembly, said rear parallel arm assembly, and said cart support between said first and second positions includes first and second hydraulic cylinders, said first hydraulic cylinder being pivotally secured to and extending between said front support and said front parallel arm assembly, said second hydraulic cylinder being pivotally secured to and extending between said rear support and said rear parallel arm assembly.

7. The combination of claim 6 wherein each of said first and second hydraulic cylinders includes a safety flow control associated therewith to prevent free fall of the cart positioned on said cart support should hydraulic failure occur.

8. (canceled)

9. (canceled)

10. (canceled)

11. (canceled)

12. The combination of claim 19 wherein said stand includes a step portion thereon to enable a person to stand thereon.

13. The combination of claim 19 wherein said means for moving said first parallel arm assembly, said second parallel arm assembly, and said load support between said first and second positions includes first and second hydraulic cylinders, said first hydraulic cylinder being pivotally secured to and extending between said first support and said first parallel arm assembly, said second hydraulic cylinder being pivotally secured to and extending between said second support and said second parallel arm assembly.

14. The combination of claim 13 wherein each of said first and second hydraulic cylinders includes a safety flow control associated therewith to prevent free fall of the load positioned on said load support should hydraulic failure occur.

15. (canceled)

16. In combination:
a wheeled vehicle having rearward and forward ends and opposite sides including an interior compartment having a door opening at one side thereof with an elevated floor within the interior compartment;
a front support secured to the floor of the vehicle inwardly of the door opening and having a forward side, a rearward side, an inner end, an outer end, a lower end and an upper end;
a rear support secured to the floor of the vehicle inwardly of the door opening rearwardly of said front support and having a forward side, a rearward side, an inner end, an outer end, a lower end and an upper end;
a front parallel arm assembly including first and second elongated parallel arms having first and second ends;
said first ends of said first and second parallel arms of said front parallel arm assembly being pivotally secured, about horizontal axes, to said front support;
a rear parallel arm assembly including first and second elongated parallel arms having first and second ends;
said first ends of said first and second parallel arms of said rear parallel arm assembly being pivotally secured, about horizontal axes, to said rear support;
a cart support having a front end, a rear end, an upper end and a lower end;
said second ends of said first and second parallel arms of said front parallel arm assembly being pivotally secured to said upper end of said cart support at said front end thereof about horizontal axes;
said second ends of said first and second parallel arms of said rear parallel arm assembly being pivotally secured to said upper end of said cart support at said rear end thereof about horizontal axes;
said cart support including at least one cart support member extending outwardly from said lower end thereof adapted to have a cart selectively removably positioned thereon;
said front parallel arm assembly, said rear parallel arm assembly and said cart support being movable in unison between a first loading/unloading position to a second stowed position;
means for moving said front parallel arm assembly, said rear parallel arm assembly, and said cart support between said first and second positions;
said front and rear parallel arm assemblies extending outwardly through the door opening so that said cart support member is positioned outwardly of the interior compartment to permit a cart to be positioned thereon when said front parallel arm assembly, said rear parallel arm assembly, and said cart support are in the said first position;
said front and rear parallel arm assemblies extending upwardly and inwardly from said front and rear supports respectively, when said front parallel arm assembly, said rear parallel arm assembly and said cart support are in the said second position so that a cart positioned on said cart support member will be positioned within the interior compartment of the vehicle;
a stand positioned between said inner ends of said front and rear supports;
said stand including at lest one substantially horizontally disposed support ledge thereon;
said lower end of said cart support being positioned on said support ledge when said front parallel arm assembly, said rear parallel assembly, and said cart support are in the said second position.

17. The combination of claim 16 wherein said stand has a front end and a rear end and wherein a support ledge is provided on each of said front and rear ends of said stand.

18. The combination of claim 17 wherein said stand includes a cushioning bumper adjacent each of aid support ledges.

19. In combination:
a wheeled vehicle having rearward and forward ends and opposite sides including an interior compartment having a door opening formed therein with an elevated floor within the interior compartment;
a first support secured to the floor of the vehicle inwardly of the door opening and having a first side, a second side, an inner end, an outer end, a lower end and an upper end;
a second support secured to the floor of the vehicle inwardly of the door opening spaced from said first support and having a first side, a second side, an inner end, an outer end, a lower end and an upper end;
a first parallel arm assembly including first and second elongated parallel arms having first and second ends;
said first ends of said first and second parallel arms of said first parallel arm assembly being pivotally secured, about horizontal axes, to said first support;
a second parallel arm assembly including first and second elongated parallel arms having first and second ends;
said first ends of said first and second parallel arms of said second parallel arm assembly being pivotally secured, about horizontal axes, to said second support;
a load support having a first end, a second end, an upper end and a lower end;
said second ends of said first and second parallel arms of said first parallel arm assembly being pivotally secured to said upper end of said load support at said first end thereof about horizontal axes;
said second ends of said first and second parallel arms of said second parallel arm assembly being pivotally secured to said upper end of said load support at said second end thereof about horizontal axes;
said load support including at least one load support member extending outwardly from said lower end thereof adapted to have a load selectively removably positioned thereon;
said first parallel arm assembly, said second parallel arm assembly and said load support being movable in unison between a first loading/unloading position to a second stowed position;
means for moving said first parallel arm assembly, said second parallel arm assembly, and said load support between said first and second positions;
said first and second parallel arm assemblies extending outwardly through the door opening so that said load support member is positioned outwardly of the interior compartment to permit a load to be positioned thereon when said first parallel arm assembly, said second parallel arm assembly, and said load support are in the said first position;
said first and second parallel arm assemblies extending upwardly and inwardly from said first and second supports respectively, when said first parallel arm assembly, said second parallel arm assembly and said load support are in the said second position so that a load positioned on said load support member will be positioned within the interior compartment of the vehicle;
a stand positioned between said inner ends of said first and second supports;
said stand including at least one substantially horizontally disposed support ledge thereon;
said lower end of said cart support being positioned on said support ledge when said first parallel arm assembly, said second parallel arm assembly, and said cart support are in the said second position.

20. The combination of claim 19 wherein said stand has a first end and a second end and wherein a support ledge is provided on each of said first and second ends of said stand.

21. The combination of claim 20 wherein said stand includes a cushioning bumper adjacent each of aid support ledges.
